(19) United States
(12) Patent Application Publication
(10) Pub. No.: US 2014/0078637 A1
(43) Pub. Date: Mar. 20, 2014

(54) Apparatus and Method for Neutralizing Static Charge on Both Sides of a Web Exiting an Unwinding Roll

(71) Applicant: Kelly Stephen Robinson, Fairport, NY (US)

(72) Inventor: Kelly Stephen Robinson, Fairport, NY (US)

(73) Assignee: ELECTROSTATIC ANSWERS LLC, Fairport, NY (US)

(21) Appl. No.: 13/621,291

(22) Filed: Sep. 17, 2012

(51) Int. Cl. H05F 3/00; H05F 3/06

(52) U.S. Cl. CPC H05F 3/00; H05F 3/06
USPC 361/213; 361/220

(57) ABSTRACT

An apparatus and a method for neutralizing static charges on a web exiting an unwinding roll are disclosed. The apparatus comprises two static dissipaters. The first static dissipater is positioned to neutralize static charges on the outside surface of the unwinding roll. The second static dissipater is positioned to neutralize static charges on the inside surface of the web. The method comprises neutralizing static charges on the outside surface of the roll using a static neutralizer, separating the web from the roll at an unwinding nip, and subsequently neutralizing static charges on the inside surface of the web using a static neutralizer. Disclosed also are the apparatus and the method adapted for a roll that may be unwound in either the clockwise or in the counter-clockwise direction and from an unwind turret having a first spindle in a load position and a second spindle in a run position.

### RELATED APPLICATION

This patent application claims priority to provisional U.S. Patent Application 61/536,996 filed on Sep. 20, 2011 and entitled, “Apparatus and Method for Neutralizing Static Charge on an Unwinding Roll.”

### FIELD

The claimed invention generally relates to a method for neutralizing static charges, and more particularly to a method for using commercially available bipolar ion emitting devices to neutralize static charges on both sides of a web exiting an unwinding roll.

### BACKGROUND

Electrostatic charges on webs cause problems for roll-to-roll manufacturing operations. Control of static on thin, flexible webs is important for the production of packaging materials. Static charges can attract dust and contaminants to the web, shock operators, ignite flammable solvents in printing or coating operations, and cause sticking in sheeting operations. Since electrically active components are susceptible to damage from electrostatic discharges, more effective charge control in roll-to-roll manufacturing is required to build or assemble electronic products including printed electronic circuits, electronic displays and inexpensive solar cells.

Static problems in the printing industry drove the development of early static dissipating devices. In U.S. Pat. No. 836,576 to HARDWICKE, a static dissipater is disclosed that is formed using a grooved plate having needles seated and clamped in the grooves. The electrostatic charge on nearby objects induces ions to form near the tips of the needles. Static dissipaters that operate by induction are termed passive devices because no external source of power is needed for their operation. However, passive devices become inactive when the electrostatic charge on the nearby object is too small to induce ionization. As a consequence, passive devices have a characteristic of dissipating static to a low, non-zero threshold level.

Six passive static dissipaters have been disclosed; (1) a needle or an array of needles as described above, (2) a static brush, (3) tinsel, (4) a rod wrapped with tinsel, (5) an ionizing cord, and (6) an ionizing rod. In U.S. Pat. No. 1,093,491 to SMITH, a (2) static brush is claim that is formed by a slit tube holding wire fabric having conductive strands. The strands need not touch the charged object. Rather, the static brush with conductive fibers must be placed simply within the field of static electricity. In U.S. Pat. No. 1,120,984 to THOMPSON, a (3) tinsel static discharger is disclosed that is made by clamping tinsel to a light, strong rod. In U.S. Pat. No. 1,396,318 to BUNGER, a (4) rod wrapped with tinsel static discharger is disclosed that is made by a core of copper or brass pipe upon which is wound a coil of metallic tinsel. In U.S. Pat. No. 5,690,014 to LARKIN, a (5) static cord is claimed made of non-conductive fiber strands braided to form a cord. One of the strands contains conductive microfibers that provide many ionizing points. In U.S. Pat. No. 5,690,014 to LARKIN, a (6) ionizing rod is claimed made of conductive fiber strands woven into a fabric sleeve sized to fit over a non-conductive core.

An active static dissipater requires an external source of power. In U.S. Pat. No. 940,431 to CHAPMAN, a static dissipater is disclosed having one or more discharge points that are connected to an AC high voltage source. The high voltage causes ions to form at the discharge points. Active devices have the characteristic of being able to dissipate static to a very low level that is much smaller than the threshold level of static characteristic of passive devices. The non-zero, low level is caused by the difference in electronic mobility between negative ions (higher mobility) and positive ions (lower mobility). Since the negative ions move at a higher speed through air, AC static bars typically provide an abundance of negative ions.

Seven active ionizers have been disclosed; (1) the AC static bar as describe above, (2) an air assisted ionizer, (3) a grid controlled ionizer, (4) a capacitively coupled AC ionizer, (5) an AC biased brush or a pair of DC biased static brushes, (6) a radioactive dissipater, and (7) a pulsed DC ionizer. In U.S. Pat. No. 1,169,428 to ROGERS, a (2) air assisted static dissipater is claimed that is a metal tube having a row of needles and holes to allow hot air inside to tube to blow onto the charge surface. In U.S. Pat. No. 940,429 to CHAPMAN, a (3) grid controlled ionizer is claimed that is conductor with fine points energized with a DC voltage opposite in polarity to that of the surface to be neutralized and interposing a screen between the ionizer and the surface to be neutralized. In U.S. Pat. No. 2,239,695 to BENNETT, a (4) capacitively coupled AC ionizer is claimed having discharge pins that, rather than being connected directly to the high voltage power supply are instead capacitively coupled. Capacitive coupling provides two important advantages. First, the generation of positive and negative ions is balanced thus eliminating the abundance of negative ions resulting in complete neutralization of objects. A second important advantage is the elimination of accidental high voltage shocks to operators and inadvertent sparks from the static bar to nearby grounded objects. In U.S. Pat. No. 4,363,070 to KISTLER, a (5) AC biased brush is claimed for neutralizing charge. And in U.S. Pat. No. 4,517,143 to KISTLER, a (5) pair of DC biased brushes are claimed for uniformly charging a moving web. Disclosed is that the uniform charge may be zero thus neutralizing static on the moving web. In U.S. Pat. No. 2,479,882 to WALLHAUSEN, a (6) radioactive static dissipater is disclosed. And in U.S. Pat. No. 3,711,743 to BOLASNY, a (7) pulsed DC excitation for controlling electrostatic potentials. A significant improvement for pulsed DC static eliminators is claimed in U.S. Pat. No. 4,542,434 to Gehlke where the pulse shape is changed by lengthening the time between ion generating pulses. This allows ions of one polarity to move further thus extending the effective ionization range of the static neutralizer.

In roll-to-roll manufacturing operations, the statically charged object to be neutralized is the web or areas on the web that have been coated or otherwise processed. The passive or active static dissipater in FIG. 1 must be located within the field of static electricity as taught in U.S. Pat. No. 1,093,491 to SMITH. Negative static charges 115 are on the top surface 111 of web 101. A passive or active static dissipater 121 is located within the field of static electricity 133. Ions 119 formed by static dissipater 121 move towards static charges 115 being forced by the electric field 133.

The effectiveness of static dissipaters may be significantly improved by locating them in specific locations. For example, in U.S. Pat. No. 2,449,972 to BEACH shows static dissipaters located where the web exits conveyance rollers facing the side of the web that is not in contact with the rollers. This location is disclosed as preferred as the most convenient position. In subsequent research, (K. L. Clum, “Equilibrium Distribution of Charge on a Moving Conducting Film Web,” IEEE Transactions on Industry Applications, Vol. 25, No. 1, January/February 1989), shows that, in the immediate vicinity of a conveyance roller, the distribution of electrostatic charge on a web varies with the product of web speed and web electrical surface resistivity. For example, the static charge density is highest in the region where the web exits the roller for a web having a surface resistivity in the range 0.6-6×10⁺¹¹ Ohms per square moving at a speed of 1 meter per second.

The static dissipaters as previously describe are typically located to neutralize the charged web to mitigate specific problems. For example, the winding roll at the end of a roll-to-roll manufacturing process can store a large amount of static charge and consequently pose a significant risk of electrical shock to operators. U.S. Pat. No. 3,392,311 to BOETEMANN claims draping electrically grounded conductive strands (tinsel) on the winding roll so that it is substantially free of static.

However, passive and active static dissipaters are not always effective in neutralizing static charge. For example, the active or passive static dissipater in FIG. 2 is ineffective in dissipating a specific pattern of charge on an insulating web. As disclosed in U.S. Pat. No. 7,388,736 to MORIOKA, the lines of force for a sheet having positive charge on one surface and negative charge on the opposite surface, especially if the pattern has a fine pitch, are closed between the negative charges and positive charges. In FIG. 2, web 201 has negative static charges 215 on the top surface 213 and positive static charges 216 on the bottom surface 214. Electric field 233 extends between the positive static charges 216 and the negative static charges 215 The electric field 233 is substantially confined to the region between the top surface 213 and bottom surface 214. Consequently, ions 217 formed by static dissipater 221 are not drawn toward the web 201. Hence, the static eliminators as previously discussed are ineffective in neutralizing a pattern of static charge where one surface has positive charge and the other surface has negative charge.

In U.S. Pat. No. 3,470,417 to GIBBONS, this charge pattern having equal but opposite charges on opposite sides of the material is termed “polar charge.” Claimed is a method of neutralizing polar charge by positioning the web carrying polar charge between two facing, grid controlled AC ionizers. The ionizers are energized in a cooperative way so that when the first ionizer is energized with the positive voltage portion of the AC sinusoidal waveform, the second ionizer is energized with the negative voltage portion of the AC sinusoidal waveform. Hence, ions generated by the first ionizer are attracted towards the web by the ions of opposite polarity generated by the second ionizer. While this method is effective, disclosed in U.S. Pat. No. 7,388,736 to MORIOKA are sequential pairs of ionizers to improve neutralization performance by extending the time that the web is exposed to ions generated by the ionizers.

Polar charge is an important problem because the electric potential of a winding roll in FIG. 3 increases with each wound lap as disclosed in U.S. Pat. No. 7,388,736 to MORIOKA. An electrically neutral web 312 enters a nip formed by polymer covered roller 303 and metal roller 304. Triboelectric charging occurs when two chemically different surfaces touch and separate. Upon exiting the nip, the surface of polymer roller 303 having touched web 312 carries negative static charges 317. The bottom surface of web 314 having touched polymer roller 303 carries positive static charges 316 that are equal in magnitude and opposite in polarity to charge 317 on the surface of the polymer covered roller 303. Note that triboelectric charging between metal roller 304 and the top surface 313 of web 312 is greatly smaller and insignificant compared with the triboelectric charging between polymer roller 303 and the bottom surface 314 of web 312. A passive or active static dissipater 321 is located in a convenient location above the web facing the top surface 313 of the web 312. The static dissipater is positioned within the electric field of positive static charges 316. Consequently, static dissipater delivers negative charges 319 to the top surface of the web. The web entering the winding roll 306 is electrically neutral having positive static charges 316 on the bottom surface 314 and an equal amount of negative static charges 319 on the top surface 313 deposited by the static dissipater. However, the web carries polar charge. An electrostatic voltmeter 331 measures the electric potential of the first lap of the winding roll to be non-zero. The electric potential of one lap is typically in the range ±0.5-±100 volts. For the purpose of illustration, the electric potential of the lap is taken to be −10 volts, which is typical of Tribocharge web surfaces. The voltage is additive with each layer, so that the electric potential of the winding roll with 10 laps would be −100 volts. As the roll builds with thousands of laps, the electric potential of the winding roll can exceed ±20 KV causing sparks, electrical discharges, and shocks to operators.

It is desirable to have a way to neutralize polar charge, defined to be a charge pattern having static charges on one surface of a web and an equal amount of oppositely polarity static charges on the other surface. The means for neutralizing polar charge by supporting the web between pairs of facing AC static dissipaters is expensive. In addition, as the web speed increases beyond one hundred meters per minute, the effectiveness of pairs of facing AC static dissipaters to neutralizing polar charge decreases. It is desirable to have a method to neutralize polar charge for high speed roll-to-roll manufacturing operations where the web speeds exceed one hundred meters per minute.

### SUMMARY

A static control method is disclosed for neutralizing static charges on both surfaces of a web exiting an unwinding roll. The static control method uses two static dissipaters. A first dissipater is located near the outside surface of the roll and it is positioned to neutralize the outside surface of the unwinding roll. A second dissipater is positioned to neutralize the inside surface of the web exiting the unwinding roll. The second dissipater is located along the web path prior to the first conveyance roller that touches the outside surface of the web.

### BRIEF DESCRIPTION OF THE DRAWINGS

It will be appreciated that for purposes of clarity and where deemed appropriate that the various elements in the drawings have not necessarily been drawn to scale in order to better show the features.

FIG. 1 illustrates the operation of a static dissipater that is located within the electric field of the static charges on the top surface of a web.

FIG. 2 shows that the same static dissipater that would be effective in neutralizing charge located on only the top surface of the web is ineffective in neutralizing polar charge, which is a charge pattern where the web has static charges on a first surface and an equal amount of static charges having the opposite polarity on the second surface.

FIG. 3 shows that polar charge is an important issue because a winding a roll of web having polar charge results in the electric potential of the outside surface of the roll that increasing with each lap and become sufficiently large to cause sparks, electrical discharge, and shock operators.

FIG. 4 illustrates triboelectric charging that occurs at the unwinding nip of an unwinding roll.

FIG. 5 shows that triboelectric charging at the unwinding nip results in an electrostatic potential on the surface of the unwinding roll and polar charge on the web exiting the unwinding roll.

FIG. 6 shows the results of a theoretical calculation of the electric potential on the outside surface of an unwinding roll where the voltage can exceed 50 KV.

FIG. 7 illustrates the first embodiment of the apparatus to neutralize static on both sides of a web exiting an unwinding roll.

FIG. 8 shows that the conveyance rollers between the unwinding roll and the second static dissipater must touch the inside surface of the web because pre-nip ionization contributes to static neutralization.

FIG. 9 shows that when a conveyance roller touches the outside surface of a web with static only on the inside surface, pre-nip ionization forms polar charge.

FIGS. 10 and 11 illustrate a second embodiment of the apparatus to neutralize both surfaces of a web exiting an unwinding roll where the apparatus is adapted for rolls that can be unwound in either the clockwise or the counter-clockwise direction.

FIGS. 12, 13, 14, and 15 illustrate a third embodiment of the apparatus to neutralize both surfaces of a web exiting an unwinding roll where the apparatus is adapted for an unwinding turret having a first unwinding spindle in a load position and a second unwinding spindle in a run position.

### DESCRIPTION

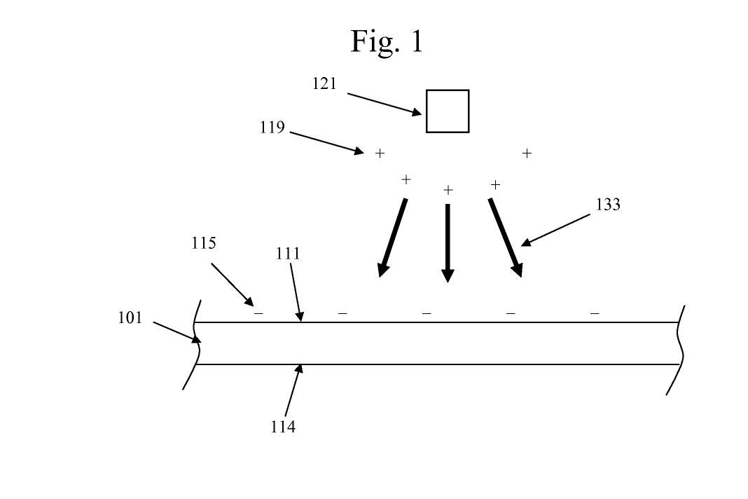

In roll-to-roll manufacturing operations, the statically charged object to be neutralized is the web or areas on the web that have been coated or otherwise processed. The passive or active static dissipater in FIG. 1 must be located within the field of static electricity. Negative static charges 115 are on the top surface 111 of web 101. A passive or active static dissipater 121 is located within the electric field 133 induce by static charges 115. Static dissipater 121 forms ions 119 that move towards static charges 115 being forced by the electric field 133.

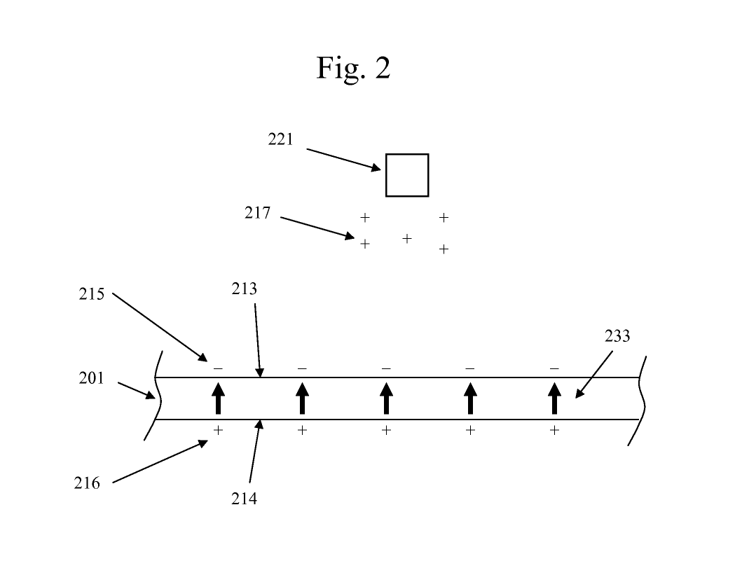

The active or passive static dissipater in FIG. 2 is ineffective in dissipating polar charge. In FIG. 2, web 201 has negative static charges 215 on the top surface 213 and positive static charges 216 on the bottom surface 214. Electric field 233 extends between the positive static charges 216 and the negative static charges 215. The electric field 233 is substantially confined to the interior region of the web 201 between the top surface 215 and the bottom surface 214. Consequently, ions 217 formed by static dissipater 221 are not drawn toward the web 201. Hence, the passive or active static dissipater 221 is ineffective in neutralizing polar charge.

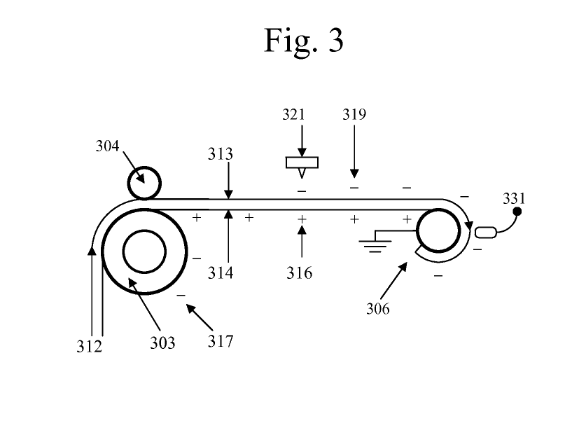

Polar charge is an important problem because the electric potential of a winding roll in FIG. 3 increases with each wound lap. An electrically neutral web 312 enters a nip formed by polymer covered roller 303 and metal roller 304. Triboelectric charging occurs when two chemically different surfaces touch and separate. Upon exiting the nip, the surface of polymer roller 303 having touched web 312 carries negative static charges 317. The bottom surface of web 314 having touched polymer roller 303 carries positive static charges 316 that are equal in magnitude and opposite in polarity to charges 317 on the surface of the polymer covered roller 303. Note that triboelectric charging between metal roller 304 and the top surface 313 of web 312 is greatly smaller and insignificant compared with the triboelectric charging between polymer roller 303 and web 312. A passive or active static dissipater 321 is located in a convenient location above the web facing the top surface 313 of the web 312 and located within the electric field of positive static charges 316. Consequently, static dissipater delivers negative charges 319 to the top surface of the web. The web entering the winding roll 306 is electrically neutral having positive static charges 316 on the bottom surface 314 and an equal amount of negative static charges 319 on the top surface 313 deposited by the static dissipater. However, the web carries polar charge. An electrostatic voltmeter 331 measures the electric potential of the first lap of the winding roll to be non-zero. The electric potential of one lap is typically in the range ±0.5-±100 volts. For the purpose of illustration, the electric potential of the lap is taken to be −10 volts, which is typical of triboelectrically charged web surfaces. The voltage is additive with each layer, so that the electric potential of the winding roll with 10 laps would be −100 volts. As the roll builds with thousands of laps, the electric potential of the winding roll can exceed ±20 KV causing sparks, electrical discharges, and shocks to operators.

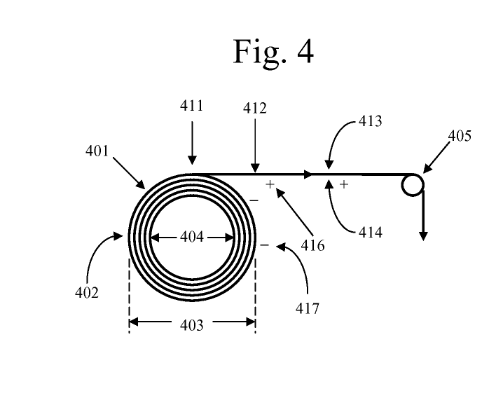

FIG. 4 illustrates triboelectric charging that occurs at the unwinding nip of an roll. Roll 401 with outside diameter 403 is wrapped on a core having a diameter 404. At the unwinding nip 411, the outer lap of web exits the roll. The first span of web 412 extends from the unwinding nip to the first conveyance roller 405. The unwinding roll has an outside surface 402. The first web span has an outside surface 413 that corresponds to the outside surface of the unwinding roll 402 and an inside surface 414. At the unwinding nip, the inside surface of the first web span is peeled from the outside surface of the unwinding roll. The outside surface of the unwinding roll and the inside surface of the first web span may be chemically different when, for example, the web is a laminate or has been coated on one side. When two chemically different surfaces touch and separate, tribocharging causes one surface to carry positive static charges and the other surface to carry an equal amount of negative static charges. To illustrate tribocharging, the unwinding roll in FIG. 4 has turned a quarter turn clockwise. Here, the outside surface of the roll has negative static charges 417 and the inside surface of the first web span has positive static charges 416. The polarities of the charged surfaces may be reversed depending on the relative positions of the materials on the triboelectric series.

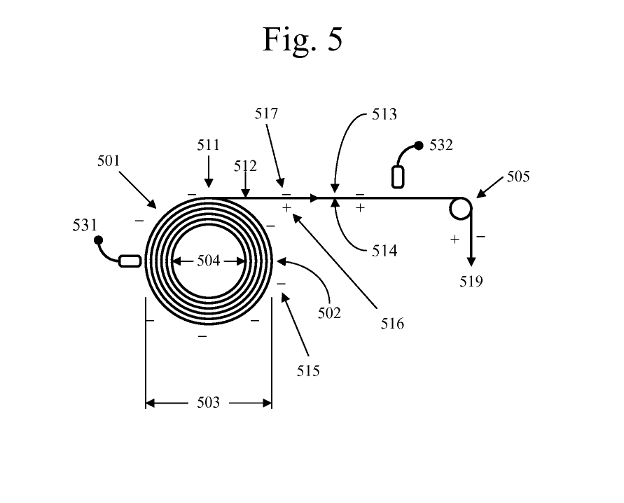

FIG. 5 shows the electrostatic charge distribution as the roll continues to unwind. Roll 501 with outside diameter 503 is wrapped on a core having a diameter 504. At the unwinding nip 511, the outer lap of web exits the unwinding roll. The first span of web 512 extends from the unwinding nip to the first conveyance roller 505. The roll has an outside surface 502. The first web span has an outside surface 513 that corresponds to the outside surface of the roll and an inside surface 514. At the unwinding nip, the inside surface of the first web span is peeled from the outside surface of the roll. Tribocharging causes the outside surface of the roll to have negative static charges 515 and causes the inside surface of the first web span to have positive static charges 516. As the roll unwinds, the top surface of the first span carries the negative charges 517 formerly on the outside surface of the unwinding roll. Consequently, the web span exiting has polar charge, defined as positive charge on one surface and an equal amount of negative charge on the other surface. This charge distribution is confirmed by measuring the electric field near the first span of web exiting the unwinding roll using an electrostatic fieldmeter 532 to find that the electric field is nearly zero. The electric potential of the unwinding roll is measured using electrostatic voltmeter 531 to find that the potential is highly negative.

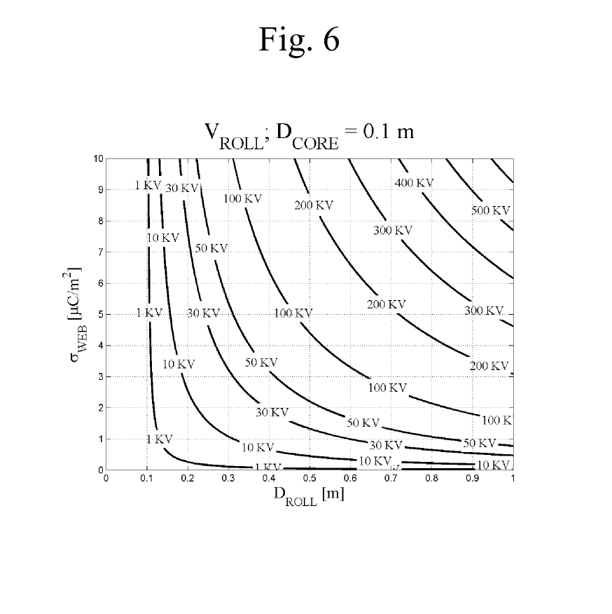

FIG. 6 shows the results of a theoretical calculation of the electric potential on the outside surface of an unwinding roll. The voltage is calculated using the capacitance of the roll.

Q_{ROLL}=C_{ROLL}V_{ROLL} (1)

The charge Q_{ROLL} on the surface of the roll is written in terms of the web charge density σ_{WEB} in (2).

Q_{ROLL}=σ_{WEB}A_{ROLL}=σ_{WEB}(πD_{ROLL}W_{WEB}) (2)

The roll capacitance C_{ROLL} is estimated in (3) as the capacitance between concentric cylinders (Smythe, W. R., “2.04. Cylindrical Capacitors,” Static and Dynamic Electricity, 3rd ed., McGraw-Hill, New York, 1968, pg. 28).

$${C}_{ROLL} = \frac{2 π {κ}_{WEB} {ɛ}_{0} {W}_{WEB}}{ln ( \frac{{D}_{ROLL}}{{D}_{CORE}} )} \qquad ( 3 )$$

Solve (1) for V_{ROLL} and use (2) and (3) to find (4) that is plotted in FIG. 6 for a 0.1 m (˜4 inch) roll core diameter.

$${V}_{ROLL} = \frac{{σ}_{WEB} {D}_{ROLL}}{2 {κ}_{WEB} {ɛ}_{0}} ln ( \frac{{D}_{ROLL}}{{D}_{CORE}} ) \qquad ( 4 )$$

For a surface charge density of 1 μC/m², which is typical of tribocharging, the voltage of large rolls (1 m diameter) can exceed 50 KV. This voltage is sufficiently high to cause sparks from the roll surface to the core along the sidewall of the roll. Sparks may also occur between the roll surface and nearby grounded objects such as the machine frame or operators.

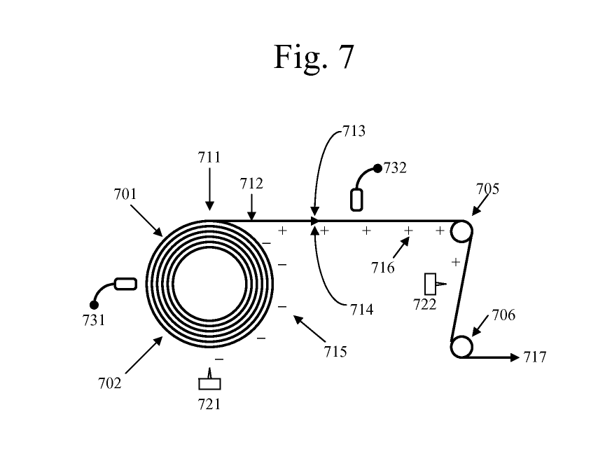

FIG. 7 illustrates the first embodiment of the apparatus to neutralize static charges on both sides of a web exiting an unwinding roll. The web 712 exits the roll 701 at the unwinding nip 711. Tribocharging causes the outside surface 702 of the roll to have negative static charge 715 and causes the inside surface 714 of the web exiting the roll to have positive static charge 716. Static dissipater 721 is positioned to neutralize static charge on the outside surface of the roll. Electrostatic voltmeter 731 confirms that the electric potential of the outside surface of the unwinding roll is zero. As a result of neutralization by static dissipater 721, the outside surface 713 of the web exiting the roll is now electrically neutral. Electrostatic fieldmeter 732 confirms that the electric field near the web exiting the unwinding roll is highly positive due to the positive charge on the inside surface of the web span. Static dissipater 722 is positioned after the first conveyance roller 705 and prior to the second conveyance roller 706 to neutralize static charge on the inside surface of the web. As a result, the exiting web 717 is electrically neutral.

The neutralizing performance of a passive or active static dissipater decreases with increasing distance from the charged object. Static dissipater 721 is positioned to neutralize the outside surface of the roll. However, the outside diameter of the roll decreases with time. For mechanical simplicity, static dissipater 721 is preferably mounted in a fixed position. As the roll diameter decreases, the distance between dissipater 721 and the outside surface 702 of the unwinding roll increases. While static dissipater 721 can be a passive or active, using an active dissipater is preferred because active static dissipaters have a greater range of neutralization than passive static dissipaters. Most preferred is to use a pulsed DC energized ionizer where the pulse shape is changed by lengthening the time between ion generating pulses. This allows ions of one polarity to move further thus extending the effective ionization range of the static neutralizer as describe in U.S. Pat. No. 4,542,434 to Gehlke.

Static dissipater 722 could be located along the first web span 712 exiting the roll 701. However, the outside diameter of the roll 701 decreases with time. For mechanical simplicity, static dissipater 722 is preferably mounted in a fixed position. As the diameter of the unwinding roll 701 decreases, the unwinding nip 711 moves towards the core and the physical location of the first web span 712 moves. Hence, the distance between static dissipater 722 and the first web span 712 would decrease with time changing the neutralizing performance of the dissipater. Locating static dissipater 722 after the first conveyance roll is preferred because the position of the web span is determined by the fixed locations of conveyance rollers 705 and 706. Consequently, the distance between the dissipater 722 and the web is constant. This constant spacing enables good performance of static dissipater 722 when using either passive or active devices. Preferably, static dissipater 722 is a pulsed DC device with balance ion output as taught by U.S. Pat. No. 3,711,743 to BOLASNY.

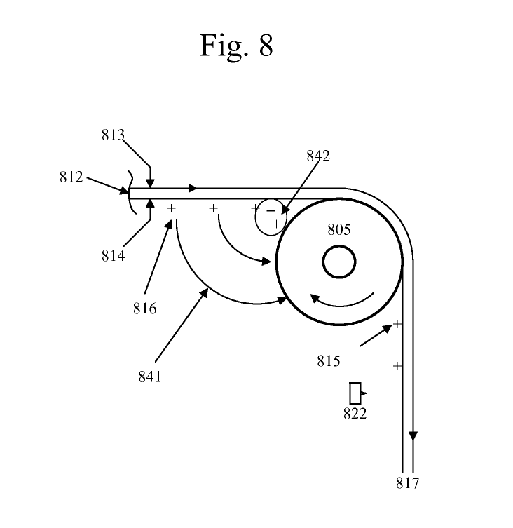

After neutralizing the static charges on the outside surface of the roll, the web 812 in FIG. 8 exiting the roll will have static charges 816 located on the inside surface 814. On the web path between the unwinding roll and static dissipater 822, all conveyance rollers must touch the inside surface of the web. As the charged web 812 approaches the first conveyance roller 805, an electric field the electric field 841 will extend between the static charges 816 and the roller 805. Because roller 805 touches the inside surface 814 of the web, the electric fields 841 do not cross through web 812. When the density of static charges 816 exceeds a threshold level of approximately ±4 μC/m², the electric field exceeds the breakdown strength of air forming a region of ionization 842, commonly called pre-nip ionization. Within the region of ionization, positive and negative ions are formed. The ions with a polarity the same as static charges 816 deposit on the roller. The ions with a polarity opposite to static charges 816 deposit on the inside surface 814 of the web and partially neutralize the static. The result is that static charges 815 on the inside web surface exiting the roller are partially neutralized. Static dissipater 822 facing the inside web surface 814 located along the web path after roller 805 neutralizes the static charges 815 remaining on the inside surface 814 of the web. As a consequence, the exiting web 817 is fully neutralized and carries no static charge.

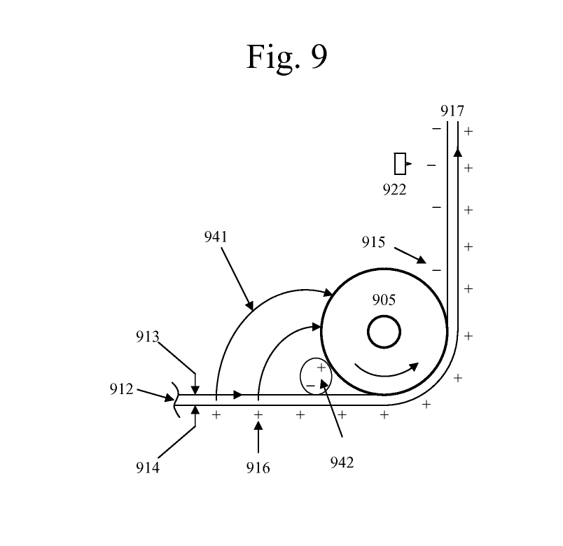

In contrast to the roller 805 in FIG. 8, roller 905 in FIG. 9 touches the outside surface 913 of the web exiting the roll. FIG. 9 illustrates that static neutralization is compromised by a roller that touches the outside surface of the web prior to static dissipater 922. After neutralizing the static charges on the outside surface of the roll, the web 912 in FIG. 9 exiting the roll will have static charges 916 located on the inside surface 914. As the charged web 912 approaches conveyance roller 905, an electric field the electric field 941 will extend between the static charges 916 and the roller 905. Because roller 905 touches the outside surface 913 of the web, the electric fields 941 cross web 912. When the density of static charges 916 exceeds a threshold level of approximately ±4 μC/m², the electric field exceeds the breakdown strength of air forming a region of ionization 942, commonly called pre-nip ionization. Within the region of ionization, positive and negative ions are formed. The ions with a polarity the same as static charges 916 deposit on the roller. The ions with a polarity opposite to static charges 916 deposit on the outside surface 913 of the web. The result is that static charges 915 deposited by pre-nip ionization reside on the outside web surface exiting the roller. Charges 916 on the inside surface of the web are unchanged and remain on the exiting web 917. The charges 915 and 916 on the web exiting roller 905 are a combination of polar charge, paired positive and negative charges residing on opposite surfaces of the web, and an abundance of unpaired positive charges residing on the inside surface 914 of the web. Static dissipater 922 facing the outside web surface 913 located along the web path after roller 905 responds only to the unpaired positive charges on the inside surface and deposits additional negative charges on the outside surface 913 equal in magnitude to the number of unpaired positive charges on the inside web surface 914. The consequence it that the exiting web 917 carries polar charge were each charge on the inside surface 914 of the web 912 exiting the roll has a paired charge of opposite polarity on the outside surface 913.

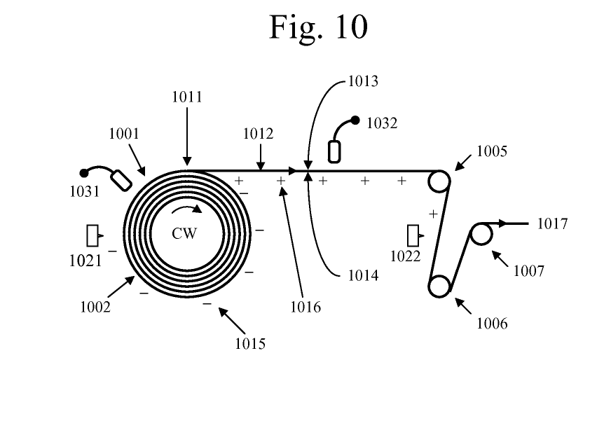

FIG. 10 illustrates a second embodiment of the apparatus to neutralize static charges on both surfaces of a web exiting an unwinding roll where the apparatus is adapted for rolls that can be unwound in either the clockwise or the counter-clockwise direction. The advantage of this second embodiment is that only a simple change in web path is needed when the unwind direction of the roll is changed. The locations of the static dissipaters are fixed and unchanged.

In FIG. 10, a roll 1001 is unwound in the clockwise direction. A web 1012 exits the roll 1001 at an unwinding nip 1011. Tribocharging causes the outside surface 1002 of the unwinding roll to have negative static charge 1015 and causes the inside surface 1014 of the web exiting the roll to have positive static charge 1016. Static dissipater 1021 is positioned to neutralize static charge on the outside surface of the roll. Electrostatic voltmeter 1031 confirms that the electric potential of the outside surface of the unwinding roll is zero. As a result of neutralization by static dissipater 1021, the outside surface 1013 of the web exiting the roll is now electrically neutral. Electrostatic fieldmeter 1032 confirms that the electric field near the web exiting the roll is highly positive due to the positive charge on the inside surface of the web. Static dissipater 1022 is positioned after the first conveyance roller 1005 to neutralize static charge on the inside surface of the web. The web is subsequently conveyed over a second conveyance roller 1006 and a third conveyance roller 1007. As a result, the exiting web 1017 is electrically neutral.

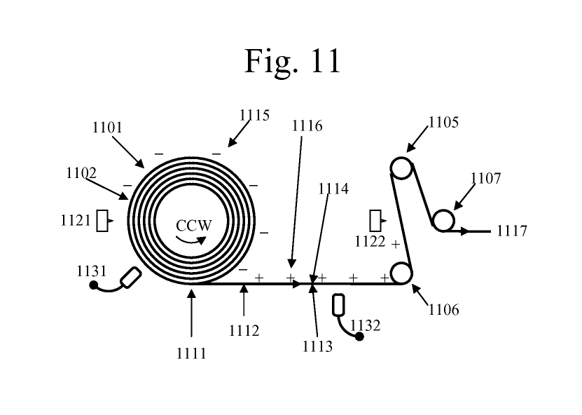

FIG. 11 illustrates the second embodiment of the apparatus to neutralize static charges on both surfaces of a web exiting an unwinding roll where the apparatus is adapted for rolls that can be unwound in either the clockwise or the counter-clockwise direction. In FIG. 11, a roll 1101 is unwound in the counter-clockwise direction. The web 1112 exits the roll 1101 at the unwinding nip 1111. Tribocharging causes the outside surface 1102 of the roll to have negative static charge 1115 and causes the inside surface 1114 of the web exiting the roll to have positive static charge 1116. Static dissipater 1121 is positioned to neutralize static charge on the outside surface of the unwinding roll. Electrostatic voltmeter 1131 confirms that the electric potential of the outside surface of the unwinding roll is zero. As a result of neutralization by static dissipater 1121, the outside surface 1113 of the web exiting the roll is electrically neutral. Electrostatic fieldmeter 1132 confirms that the electric field near the web exiting the roll is highly positive due to the positive charge on the inside surface of the web. Static dissipater 1122 is positioned after the first conveyance roller 1106 to neutralize static charge on the inside surface of the web. The web is subsequently conveyed over a second conveyance roller 1105 and a third conveyance roller 1107. As a result, the exiting web 1117 is electrically neutral.

In FIG. 10 and FIG. 11, the positions of corresponding static dissipaters 1021 & 1121 located to neutralize the unwinding roll, corresponding static dissipaters 1022 & 1122 located to neutralize the inside surface of the web, and corresponding conveyance rollers 1005 & 1105, 1006 & 1106, and 1007 & 1107 are fixed. The advantage of this second embodiment of the apparatus to neutralize static charges on both sides of a web exiting an unwinding roll is that only a simple change to web path is needed when the unwind direction of the roll is changed. The locations of the static dissipaters are fixed and unchanged.

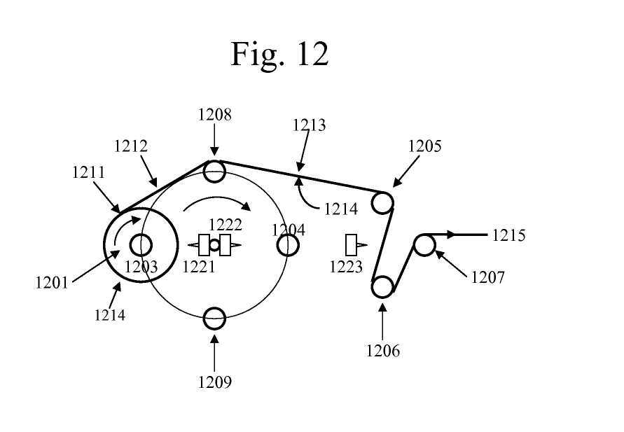

FIGS. 12 through 15 illustrate a third embodiment of the apparatus to neutralize static charge on both sides of a web exiting an unwinding turret. Many roll-to-roll manufacturing operations use an unwinding turret a first unwind spindle A in a load position farther from the conveyance path of the operation and a second unwind spindle B in a run position nearer to the conveyance path of the operation. While an old roll unwinds on spindle B in the run position, a new roll may be loaded onto spindle A in a load position typically using cranes and other roll handling equipment. The unwind turret is often designed to unwind rolls in either a clockwise or a counter clockwise direction. The advantage of this third embodiment is that the locations of the static dissipaters are fixed and unchanged. Static is neutralized effective while the roll on either spindle A or B is unwound in either the clockwise or the counter-clockwise direction, and while the turret rotates in either the clockwise or the counter clockwise direction.

FIG. 12 shows a turret unwinder where spindle B 1204 in a run position nearer to conveyance roller 1205, 1206 and 1207 and spindle A 1203 is farther from the conveyance rollers. No web remains on the roll on spindle B and a new roll 1201 on spindle A 1203 is rotating in the clockwise direction to unwind web 1212. The web 1212 exits the roll 1201 at the unwinding nip 1211. Tribocharging causes the outside surface 1202 of the roll to have negative static charge (not shown) and causes the inside surface 1214 of the web exiting the roll to have positive static charge (not shown). Static dissipater 1221 is positioned to neutralize static charge on the outside surface of the roll on spindle A. As a result of neutralization by static dissipater 1221, the outside surface 1213 of the web exiting the roll is now electrically neutral. The web is conveyed over roller 1208 that is mounted on the turret and subsequently over roller 1205 that is mounted in a fixed location. Static dissipater 1223 is positioned after the conveyance roller 1205 to neutralize static charge on the inside surface of the web. The web is subsequently conveyed next over conveyance roller 1206 and conveyance roller 1207. As a result, the exiting web 1215 is electrically neutral.

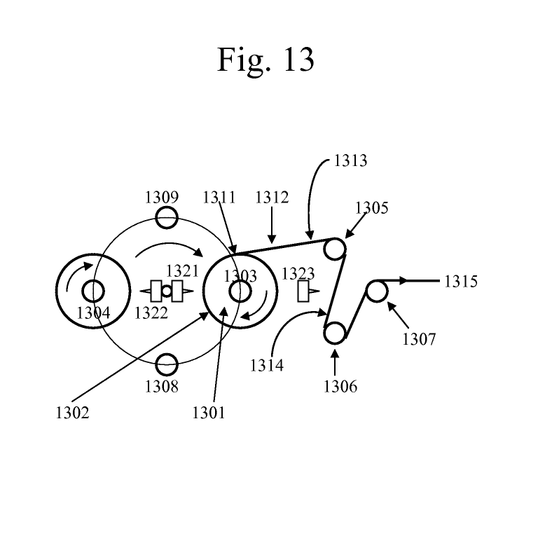

While roll 1201 in FIG. 12 is unwinding, the turret rotates in the clockwise direction to move the unwinding roll 1201 from the load position that is farther away from conveyance rollers 1205, 1206 and 1207 to the run position that is nearer to the conveyance rollers as shown in FIG. 13. Conveyance roller 1208 located above static dissipaters 1221 and 1222 with unwinding roll 1201 in the load position in FIG. 12 rotates with the turret to become conveyance roller 1308 in FIG. 13 located below static dissipaters 1321 and 1322 with unwinding roll 1301 in the run position.

FIG. 13 shows a turret unwinder where spindle B 1204 in a load position farther from conveyance roller 1305, 1306 and 1307 and spindle A 1303 is in the run position nearer to the conveyance rollers. The roll 1301 on spindle A 1303 is rotating in the clockwise direction to unwind web 1312. The web 1312 exits the roll 1301 at the unwinding nip 1311. Tribocharging causes the outside surface 1302 of the unwinding roll to carry static charges (not shown) and causes the inside surface 1314 of the web exiting the roll to carry static charges (not shown) having equal magnitude and opposite polarity to the charges on the roll. Static dissipater 1321 located on the turret so that it rotates with the turret is positioned to neutralize static charge on the outside surface of the roll on spindle A. As a result of neutralization by static dissipater 1321, the outside surface 1313 of the web exiting the roll is now electrically neutral. With the spindle 1303 in the run position, the web is conveyed directly from the unwinding nip 1311 to roller 1305 that is mounted in a fixed location. Static dissipater 1323 in a fixed location after the conveyance roller 1305 is positioned to neutralize static charge on the inside surface of the web. The web is subsequently conveyed next over conveyance roller 1306 and conveyance roller 1307. As a result, the exiting web 1315 is electrically neutral.

FIG. 12 shows the unwinding roll 1201 on spindle A in the load position where the outside surface 1214 of the roll is neutralized by static dissipater 1221. When a roll is on spindle B 1204, static neutralizer 1222 is located to neutralize the outside surface. The geometry is akin to FIG. 13 showing roll 1301.

Similarly, FIG. 13 shows the roll 1301 on spindle A in the run position where the outside surface 1314 of the roll is neutralized by static dissipater 1321. When a roll is on spindle B 1304, static neutralizer 1322 is located to neutralize the outside surface of the roll. The geometry is akin to FIG. 12 showing roll 1201.

In FIG. 12 and FIG. 13, the positions of corresponding static dissipaters 1221 & 1321 located to neutralize the unwinding roll, corresponding static dissipaters 1223 & 1323 located to neutralize the inside surface of the web, and corresponding conveyance rollers 1205 & 1305, 1206 & 1306, and 1207 & 1307 are fixed. The roll loading operations and turret rotation can proceed with no change to the location of the static neutralizers. The advantage of this third embodiment of the apparatus to neutralize both sides of a web exiting an unwinding roll is that the locations of the static dissipaters are fixed and unchanged. Static is effectively neutralized while a roll on either spindle A or spindle B unwinds and while the turret rotates in a clockwise direction.

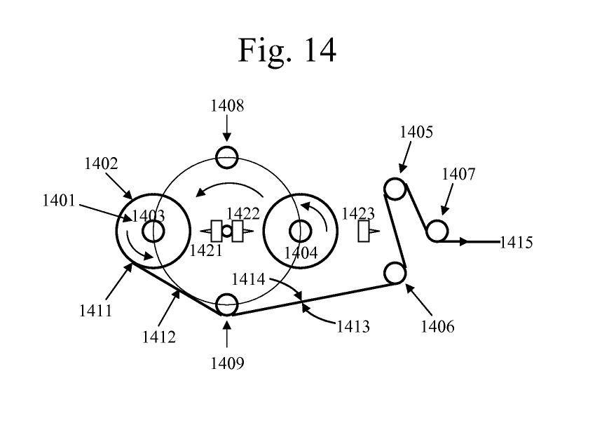

FIG. 14 shows the turret unwinder where spindle B 1404 in a run position nearer to conveyance roller 1405, 1406 and 1407 and spindle A 1403 is farther from the conveyance rollers. No web remains on the roll on spindle B and a new roll 1401 on spindle A 1403 is rotating in the counter-clockwise direction to unwind web 1412. The web 1412 exits the roll 1401 at the unwinding nip 1411. Tribocharging causes the outside surface 1402 of the roll to have static charge (not shown) of a first polarity and causes the inside surface 1414 of the web exiting the unwinding roll to have static charge (not shown) of the second opposite polarity. Static dissipater 1421 is located on the turret so that it rotates with the turret and it is positioned to neutralize static charge on the outside surface of the roll 1401 on spindle A. As a result of neutralization by static dissipater 1421, the outside surface 1413 of the web exiting the roll is now electrically neutral. The web is conveyed over roller 1409 that is mounted on the turret and subsequently over roller 1406 that is mounted in a fixed location. Static dissipater 1423 is positioned after the conveyance roller 1406 to neutralize static charge on the inside surface of the web. The web is subsequently conveyed next over conveyance roller 1405 and conveyance roller 1407. As a result, the exiting web 1415 is electrically neutral.

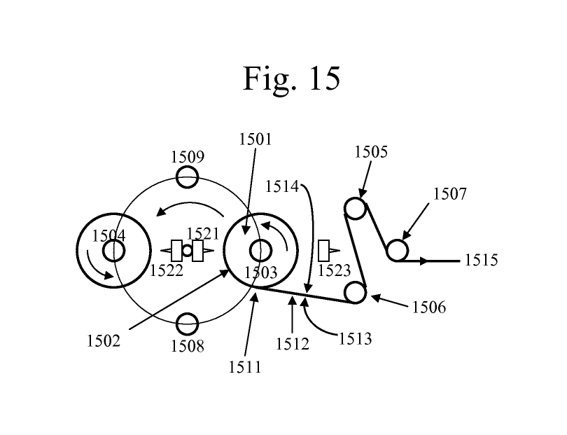

While roll 1401 in FIG. 14 is unwinding, the turret rotates in the counter-clockwise direction to move the unwinding roll 1401 from the load position farther away from conveyance rollers 1405, 1406 and 1407 to the run position nearer to the conveyance rollers as shown in FIG. 15. Conveyance roller 1409 located below static dissipaters 1421 and 1422 with unwinding roll 1401 in the load position in FIG. 14 rotates with the turret to become conveyance roller 1509 in FIG. 15 located above static dissipaters 1521 and 1522 with unwinding roll 1501 in the run position.

FIG. 15 shows a turret unwinder where spindle B 1504 in a load position farther from conveyance roller 1505, 1506 and 1507 and spindle A 1503 is in the run position nearer to the conveyance rollers. The unwinding roll 1501 on spindle A 1503 is rotating in the counter-clockwise direction to unwind web 1512. The web 1512 exits the roll 1501 at the unwinding nip 1511. Tribocharging causes the outside surface 1502 of the roll to have static charge (not shown) of a first polarity and causes the inside surface 1514 of the web exiting the unwinding roll to have static charge (not shown) of a second, opposite polarity. Static dissipater 1521 located on the turret so that it rotates with the turret is positioned to neutralize static charge on the outside surface of the roll on spindle A. As a result of neutralization by static dissipater 1521, the outside surface 1513 of the web exiting the roll is now electrically neutral. The web is now conveyed directly to roller 1506 that is mounted in a fixed location. Static dissipater 1523 is located in a fixed position after the conveyance roller 1506 and it is positioned to neutralize static charge on the inside surface of the web. The web is subsequently conveyed next over conveyance roller 1505 and conveyance roller 1507. As a result, the exiting web 1515 is electrically neutral.

FIG. 14 shows the unwinding roll 1401 on spindle A in the load position where the outside surface 1414 of the roll is neutralized by static dissipater 1421. When a roll is on spindle B 1404, static neutralizer 1422 is located to neutralize the outside surface of the roll. The geometry is akin to FIG. 15 showing roll 1501.

Similarly, FIG. 15 shows the unwinding roll 1501 on spindle A in the run position where the outside surface 1514 of the roll is neutralized by static dissipater 1521. When an roll is on spindle B 1504, static neutralizer 1522 is located to neutralize the outside surface of the roll. The geometry is akin to FIG. 14 showing unwinding roll 1401.

In FIG. 14 and FIG. 15, the positions of corresponding static dissipaters 1421 & 1521 located to neutralize the unwinding roll, corresponding static dissipaters 1423 & 1523 located to neutralize the inside surface of the web, and corresponding conveyance rollers 1405 & 1505, 1406 & 1506, and 1407 & 1507 are in fixed locations. The roll loading operations and turret rotation can proceed with no change to the locations of the static neutralizers. In FIGS. 12, 13, 14, and 15, the positions of corresponding static dissipaters 1221, 1321, 1421 & 1521 located to neutralize the inside surface of the web are unchanged with the rolls being unwound in either the load or run positions, while the turret rotates in either the clockwise or in the counter-clockwise direction, and while the rolls are unwound in either the clockwise or counter-clockwise direction. The advantage of this third embodiment of the apparatus to neutralize static on both surfaces of a web exiting an unwinding roll is that the locations of the static dissipaters are fixed and unchanged. Static is effectively neutralized while a roll on spindle A or on spindle B unwinds in the clockwise direction or in the counter-clockwise direction and while the turret rotates in a clockwise direction.

Accordingly, the claimed invention is limited only by the following claims and equivalents thereto.

What is claimed is:

1. A static charge neutralizing apparatus, comprising:
a roll of web wound on a core;
the roll having a first lap of web and remaining laps between the first lap and the core;
the first lap of web having an exposed outside surface and an inside surface in contact with the remaining laps;
an unwinding nip where the outer lap of web exits the roll;
a first static neutralizing device located in proximity to the roll that is positioned to neutralize static on the exposed outside surface of the first lap;
a first roller located in proximity to the unwinding nip;
a web path comprising a first web span extending from the unwinding nip to the first roller;
the first web span having outside and inside surfaces corresponding respectively to the outside and inside surfaces of the first lap of web;
the first roller positioned to touch the inside surface of the first web span;
a second roller located in proximity to the first roller;
the web path further comprising a second web span extending from the first roller to the second roller;
the second web span having outside and inside surfaces corresponding respectively to the outside and inside surface of the first web span; and
a second static neutralizing device located in proximity to the second web span positioned to neutralize static charges on the inside surface of the second web span.

2. The static charge neutralizing apparatus of claim 1 wherein the first static neutralizing device is selected from the group consisting of a tinsel, an antistatic brush, an ionizing string, an ionizing rod, a radioactive ion emitter, an AC powered corona ion emitter, a pulsed DC powered corona ion emitter, and a pulsed DC powered corona ion emitter with where the pulse shape is changed by lengthening the time between ion generating pulses.

3. The static charge neutralizing apparatus of claim 1 wherein the first static neutralizing device is a pulsed DC powered corona ion emitter with where the pulse shape is changed by lengthening the time between ion generating pulses.

4. The static charge neutralizing apparatus of claim 1 wherein the second static neutralizing device is selected from the group consisting of a tinsel, an antistatic brush, an ionizing string, an ionizing rod, a radioactive ion emitter, an AC powered corona ion emitter, a pulsed DC powered corona ion emitters, and a pulsed DC powered corona ion emitter with where the pulse shape is changed by lengthening the time between ion generating pulses.

5. The static charge neutralizing apparatus of claim 1 wherein the second static neutralizing device is a pulsed DC powered corona ion emitter.

6. The static charge neutralizing apparatus of claim 1 wherein a line extending from the center of the core to the unwinding nip defines an angular position of 0 degrees around the roll, the direction of increasing angle is the direction of rotation of the unwinding roll, and the first static neutralizing device has an angular position not less than 30 degrees and not exceeding 330 degrees.

7. A method for neutralizing a web exiting an unwinding roll comprising;
neutralizing static charges on the outer surface of a roll using a static dissipater located in the proximity of the outer surface of the roll;
separating the web from the roll at an unwinding nip;
conveying the web over a first conveyance roller positioned to touch in inside surface of the web; and
neutralizing static charges on the inside surface of the web using a static dissipater located after the first conveyance roller.

8. A static charge neutralizing apparatus, comprising:
a roll of web wound on a core;
the unwinding roll having a first lap of web and remaining laps between the first lap and the core;
the first lap of web having an exposed outside surface and an inside surface in contact with the remaining laps;
an unwinding direction that can be clockwise or counter-clockwise;
an unwinding nip where the outer lap of web exits the roll;
a first static dissipater positioned to neutralize the exposed outside surface of the first lap;
a line drawn from the center of the core to the unwinding nip when unwinding direction is clockwise defines an angular position around the unwinding roll of 0 degrees and the angular position increases in the clockwise direction;
a first roller located in proximity to the angular position of 0 degrees;
a second roller located in proximity to the angular position of 180 degrees;
a web path when the unwinding direction is clockwise comprising a first web span extending from the unwinding nip to the first roller;
a web path when the unwinding direction is clockwise further comprising a second web span extending from the first roller to the second roller;
a web path when the unwinding direction is counter-clockwise comprising a first web span extending from the unwinding nip to the second roller;
a web path when the unwinding direction is counter-clockwise further comprising a second web span extending from the second roller to the first roller;
the first web span having outside and inside surfaces corresponding respectively to the outside and inside surfaces of the first lap of web;
when the unwind direction is clockwise, the first roller positioned to touch the inside surface of the first web span;
when the unwind direction is counter-clockwise, the second roller positioned to touch the inside surface of the first web span;
the second web span having outside and inside surfaces corresponding respectively to the outside and inside surfaces of the first web span;
a second static dissipater located in proximity to the second web span positioned to neutralize static on the inside surface of the second web span.

9. The static charge neutralizing apparatus in claim 8 wherein the first static dissipater has an angular location not less than 30 degrees and not exceeding 150 degrees.

10. The static charge neutralizing apparatus in claim 8 wherein the first static dissipater has an angular location not less than 210 degrees and not exceeding 330 degrees.

11. The static charge neutralizing apparatus of claim 8 wherein the first static neutralizing device is selected from the group consisting of a tinsel, an antistatic brush, an ionizing string, an ionizing rod, a radioactive ion emitter, an AC powered corona ion emitter, a pulsed DC powered corona ion emitter, and a pulsed DC powered corona ion emitter with where the pulse shape is changed by lengthening the time between ion generating pulses.

12. The static charge neutralizing apparatus of claim 8 wherein the first static neutralizing device is a pulsed DC powered corona ion emitter with where the pulse shape is changed by lengthening the time between ion generating pulses.

13. The static charge neutralizing apparatus of claim 8 wherein the second static neutralizing device is selected from the group consisting of a tinsel, an antistatic brush, an ionizing string, an ionizing rod, a radioactive ion emitter, an AC powered corona ion emitter, a pulsed DC powered corona ion emitter, and a pulsed DC powered corona ion emitter with where the pulse shape is changed by lengthening the time between ion generating pulses.

14. The static charge neutralizing apparatus of claim 8 wherein the second static neutralizing device is a pulsed DC powered corona ion emitter.

15. A static charge neutralizing apparatus, comprising:
a unwind turret having a first spindle in a first load position that is farther away from a plurality of fixed conveyance rollers;
the unwind turret having a second spindle in a second run position that is nearer to the plurality of fixed conveyance rollers;
the turret having a means to move the first spindle from the first load position to the second run position and a means to move the second spindle from the second load position to the first load position;
a roll of web wound on a core;
the roll having a first lap of web;
the first lap of web having an exposed outside surface and an inside surface;
the roll being loaded on the first spindle in the first load position;
a first static dissipater located to neutralize the exposed outside surface of the first lap;
an unwind direction that is clockwise or counter-clockwise;
an unwinding nip where the outer lap of web exits the roll a line drawn from the center of the core to the unwinding nip when the unwind direction is clockwise defines an angular position of 0 degrees;
the angular position increasing in the direction of unwinding;
a first roller located in proximity to the angular position of 0 degrees that is located on the turret and moves with the first spindle when the turret moves the first spindle in the first load position to the second run position;
a second roller located in proximity to the angular position of 180 degrees that is located on the turret and moves with the first spindle when the turret moves the first spindle in the first load position to the second run position;
a third roller located in proximity to the angular position of 0 degrees when the roll is on the spindle in the second run position;
a fourth roller located in proximity to the angular position of 180 degrees when the roll is on the spindle in the second run position;
a web path when the unwinding direction is clockwise comprising a first web span extending from the unwinding nip to the first roller;
a web path when the unwinding direction is clockwise further comprising a second web span extending from the first roller to the third roller;
a web path when the unwinding direction is clockwise further comprising a third web span extending from the third roller to the fourth roller;
a web path when the unwinding direction is counter-clockwise comprising a first web span extending from the unwinding nip to the second roller;
a web path when the unwinding direction is counter-clockwise further comprising a second web span extending from the second roller to the fourth roller;
a web path when the unwinding direction is counter-clockwise further comprising a third web span extending from the fourth roller to the third roller;
the first web span having outside and inside surfaces corresponding respectively to the outside and inside surfaces of the first lap of web;
when the unwind direction is clockwise, the first roller positioned to touch the inside surface of the first web span;
when the unwind direction is counter-clockwise, the second roller positioned to touch the inside surface of the first web span;
the second web span having outside and inside surfaces corresponding respectively to the outside and inside surfaces of the first web span;
when the unwind direction is clockwise, the third roller positioned to touch the inside surface of the second web span;
when the unwind direction is counter-clockwise, the fourth roller positioned to touch the inside surface of the second web span; and
a second static dissipater located in proximity to the third web span and positioned to neutralize static charges on the inside surface of the second web span.

16. The static charge neutralizing apparatus in claim 15 wherein the first static neutralizing device has an angular location not less than 30 degrees and not exceeding 150 degrees.

17. The static charge neutralizing apparatus in claim 15 wherein the first static neutralizing device has an angular location not less than 210 degrees and not exceeding 330 degrees.

18. The static charge neutralizing apparatus of claim 15 wherein the first static neutralizing device is selected from the group consisting of a tinsel, an antistatic brush, an ionizing string, an ionizing rod, a radioactive ion emitter, an AC powered corona ion emitter, a pulsed DC powered corona ion emitter, and a pulsed DC powered corona ion emitter with where the pulse shape is changed by lengthening the time between ion generating pulses.

19. The static charge neutralizing apparatus of claim 15 wherein the first static neutralizing device is a pulsed DC powered corona ion emitter with where the pulse shape is changed by lengthening the time between ion generating pulses.

20. The static charge neutralizing apparatus of claim 15 wherein the second static neutralizing device is selected from the group consisting of a tinsel, an antistatic brush, an ionizing string, an ionizing rod, a radioactive ion emitter, an AC powered corona ion emitter, a pulsed DC powered corona ion emitter, and a pulsed DC powered corona ion emitter with where the pulse shape is changed by lengthening the time between ion generating pulses.

21. The static charge neutralizing apparatus of claim 15 wherein the second static neutralizing device is a pulsed DC powered corona ion emitter.
